(19) United States
(12) Patent Application Publication
(10) Pub. No.: US 2010/0015309 A1
(43) Pub. Date: Jan. 21, 2010

(54) New post-packaging pasteurization process

(75) Inventor: Sidi M. Chouikhi, Wellingborough (GB)

Correspondence Address: Cryovac, Inc., P.O. Box 464, Duncan, SC, 29334, US

(73) Assignee: Cryovac, Inc.

(21) Appl. No.: 12/460,292

(22) Filed: Jul. 16, 2009

(30) Foreign Application Priority Data
Jul. 16, 2008 (EP) 08012819.2

(51) Int. Cl. A23L 3/10

(52) U.S. Cl. 426/394; 426/412

(57) ABSTRACT

A post-packaging ultra-pasteurization process for VSP packages, particularly suitable for extended shelf-life chilled ready meals, which process comprises setting the pressure of the retort vessel where the ultra-pasteurization of the VSP package is carried out, at a value comprised between 2 and 5 bar, prior to the initiation of the heating cycle, keeping the pressure within the above range during the whole heating cycle, carried out at a temperature and for a time sufficient to provide for a 6 log reduction in the count of cold growing non-proteolytic Clostridium botulinum spores, and for most of the cooling cycle until the packaged product almost reaches room temperature. By carrying out the ultra-pasteurization of a VSP package according to the above method or protocol, it is possible to reach high temperatures, e.g., in the range 90-99° C. but even higher, e.g. up to 108-110° C., without getting any sauce splitting and also controlling the loss of moisture from the protein components of the food product.

### CROSS-REFERENCE TO RELATED APPLICATIONS

This application claims the priority, under 35 U.S.C. §119, of European Patent Application No. 08012819.2, filed Jul. 16, 2008. The prior application is incorporated by reference herein in its entirety.

### BACKGROUND

The present invention relates to a new post-packaging pasteurizing process specially designed for the vacuum skin packaging (VSP) technology. In particular the present invention relates to a new post-packaging pasteurization process for VSP packages particularly suitable for extended shelf-life chilled ready meals.

Vacuum skin packaging is a vacuum packaging process well known in the art where thermoplastic packaging materials are used to enclose a product under vacuum. The vacuum skin packaging process is in one sense a type of thermoforming process in which an article to be packaged serves as the mould for the forming upper or top web. More particularly, in vacuum skin packaging an article is placed on a lower or bottom support member and the supported article is then passed in a chamber where a formable top film is drawn upward against a heated dome and is then draped down over the article. The movement of the top web is controlled by vacuum and/or air pressure, and in a vacuum skin packaging arrangement, the interior of the container, i.e., the space between the lower or bottom support member and the upper or top web, is vacuumized before final welding of the top web to the support member. In a vacuum skin package the upper film thus forms a tight skin around the product and is sealed to the support all around the product. Skin packaging is described in many references, including French Patent No. 1,258,357, French Patent No. 1,286,018, Australian Patent No. 3,491,504, U.S. Pat. No. RE 30,009, U.S. Pat. No. 3,574,642, U.S. Pat. No. 3,681,092, U.S. Pat. No. 3,713,849, U.S. Pat. No. 4,055,672, and U.S. Pat. No. 5,346,735.

The term “ready meals” generally refers to those products, based on conventional ingredients such as meats, vegetables, and carbohydrates, either alone or more often in combination and typically with recipe skills added thereto by the manufacturer, that may be used as complete meals or meal components, with a high degree of readiness, completion and convenience. They can be divided in three sectors, i.e., the frozen sector, the ambient sector and the chilled sector, depending on the conditions in which they are then preserved. The one that is most gaining in popularity is the chilled one as the packaged products are not submitted to too severe treatments and thus maintain the taste and the nutritional properties of the starting food products. It is the sector that has almost no limitation in the use of the various ingredients and offers therefore a wider choice of different meals.

To increase the shelf-life of chilled ready meals post-packaging or in-package pasteurization is widely employed. This is a heat-treatment which is carried out on the package containing the product with the purpose to destroy bacteria, protozoa, molds, and yeasts. However, unlike sterilization, pasteurisation is not aimed at killing all pathogenic microorganisms in the product but at achieving a logarithmic reduction in their number, so that they are unlikely to cause disease during the shelf-life foreseen for the product, if the packaged product is correctly kept under refrigerated conditions.

For most of the food products but particularly for those packaged and preserved under vacuum, or under a modified atmosphere not containing oxygen, the most dangerous and resistant microorganism is Clostridium botulinum. The evaluation of whether the pasteurization treatment in these packages has been successful or not is therefore made by evaluating the reduction in the number of living spores of this anaerobic bacterium. Ultra-pasteurization is defined as the heat treatment capable of providing at least a 6 log reduction in the count of cold growing non-proteolytic Clostridium botulinum spores. This treatment will allow to extend the shelf-life of chilled ready meals beyond ten days.

The post-packaging ultra-pasteurisation, is typically carried out by loading the packaged products into a pasteurization pressure resistant vessel (generally called retort vessel), equipped with a heating and a cooling system. The temperature inside the package is first raised to a suitably selected value, and, after a suitably selected time spent at this temperature, necessary for the combination temperature/time to provide for the at least 6 log reduction in the number of Clostridium botulinum spores, the package is cooled down to room temperature and then chilled. In the ultra-pasteurization protocol currently used the heating temperature for ready meals is maintained below 99-100° C., to prevent boiling of the water contained in the food product as this would definitely lower the quality and the organoleptic properties of the food packaged. Depending on the particular food and its heat sensitivity, as well as on the particular recipe in which the food components have been combined, it might also be necessary or advisable to maintain the pasteurization temperature well below the above limit. On the other hand the spores of Clostridium botulinum have a remarkable resistance to heat and typically require temperatures around 80° C. to be destroyed. Furthermore, generally speaking, higher the temperature the shorter the time required to get the ultra-pasteurisation. Therefore the highest possible temperature, compatible with the particular food and with the desired organoleptic properties of the end product, is preferably applied in order to get a quicker and safer ultra-pasteurisation cycle. Typical values of the temperature in the conventional ultra-pasteurization processes, balancing all the above requirements, are therefore in the range from about 80° C. to about 95° C., normally from about 85° C. to about 92° C.

On the other hand typical times for the ultra-pasteurization process are comprised between at least 25 minutes, preferably at least 30 minutes, and 200 minutes or even more depending on the temperature applied, on the volume and volume/surface ratio of the packaged product, and on the effectiveness of the heat exchange between the selected heating system and the product. Generally however 180 minutes are sufficient to get the 6 log spores count reduction in the conventional ready meals packages available on the market.

During the heating step of the process, part of the water present in the food product converts into steam and the gas volume in the sealed package thus increases. To ensure that the package will not open up under the internal pressure by breakage of the heat-seal between the lidding film and the tray or bottom support, or that the lidding film will not become deformed by a possible stretch beyond the recovery limit, an overpressure is gradually applied during the heating step in the retort vessel, overpressure which is aimed at counterbalancing the increasing inner pressure. Typically values up to about 2-3 absolute bars are reached at the end of the heating step.

The ultra-pasteurization carried out according to the above conventional process has however shown to give a number of problems, mainly linked to the high temperature which is reached by the water contained in the product packaged. The main and more apparent one is the splitting of the sauces possibly present in the ready meal product into an oily and a watery component. This is due to the effect of the evaporation of water from the sauce and its subsequent condensation in the chilling step in drops separated from the oily sauce. A second undesirable effect due to the high temperature needed for the ultra-pasteurization is the loss of moisture from the protein components during the treatment. In the chilling step the moisture that was lost during the heating step will not re-hydrate the foodstuff but will appear on the product surface in the form of drops.

It has now been found that it is possible to overcome the above problems by packaging the products as VSP and using a specific protocol for the ultra-pasteurization.

More particularly it has been found that it is possible to avoid the above problems and still obtain the ultra-pasteurization of a VSP packaged product, by setting the pressure of the retort vessel, at a relatively high level prior to the initiation of the heating cycle, keeping the pressure at such a relatively high level during the whole heating cycle and for most of the cooling cycle until the packaged product almost reaches room temperature.

### SUMMARY

In some embodiments, the presently disclosed subject matter is directed to a post-packaging ultra-pasteurization process for VSP packages comprising a packaged product, wherein the process comprises setting the pressure of a retort vessel where the ultra-pasteurization of the VSP packages is carried out at a value of between 2 and 5 bar prior to the initiation of the heating cycle. The pressure is then kept within said range during the whole heating cycle-and for most of the cooling cycle until said packaged product reaches about room temperature, and wherein said heating cycle is carried out at a temperature and for a time sufficient to provide for a 6 log reduction in the count of cold growing non-proteolytic Clostridium botulinum spores.

### DETAILED DESCRIPTION

By “relatively high pressure” what is meant here is a pressure higher than 2 absolute bar (hereinafter indicated as “bar”), preferably higher than 2.1 bar, more preferably higher than 2.3 bar, e.g., 2.5, 2.7, 2.9, 3.1, 3.3, 3.5, 3.7, and 3.9 bar. The pressure applied however should not be too high to possibly damage the packaged product. Furthermore the advantages brought in by pressure values higher than 5 bar will not compensate for the additional costs involved in generating, maintaining, and removing such a higher pressure. Thus the pressure set prior to the initiation of the heating cycle, and maintained during the whole heating and most of the cooling cycle until the packaged product almost reaches room temperature, will typically be comprised between 2 and 5 bar, and more preferably between 2 and 4 bar. The pressure can then be decreased during the last part of the cooling cycle so as to reach the atmospheric value when the product is at room temperature. It is important however to avoid decreasing the pressure when the temperature of the packaged product is still high enough to generate a large volume of steam inside the package. In a preferred embodiment therefore the pressure in the ultra-pasteurization vessel is maintained in the range between 2 and 5 bar, preferably between 2 and 4 bar, until the packaged product reaches room temperature (i.e., about 25° C.) and it is decreased to the atmospheric value during the further chilling of the package.

By carrying out the ultra-pasteurization of a VSP package according to the above method or protocol, it is possible to reach high temperatures, e.g., in the range 90-99° C. but even higher, e.g. up to 108-110° C., without getting any sauce splitting and also controlling the loss of moisture from the protein components of the food product. In case of a VSP package in fact the high pressure in the ultra-pasteurization vessel will be transmitted by the skin top film to the inner part of the package. An increase in pressure will increase the boiling temperature of the water contained in the sauce and in the food product and will decrease the vapour pressure (i.e., the pressure exerted by the molecules that escape from the water contained in the sauce or in the protein components of the food product to form a separate vapour phase above the sauce/product surface) in the temperature range from room temperature, as the high pressure is applied in the retort vessel prior to the beginning of the heating cycle, to the temperature selected for the ultra-pasteurization. This will mean that a temperature sufficiently high to destroy the Clostridium botulinum spores can be attained without getting, during the whole ultra-pasteurization cycle, a noticeable sauce splitting effect or a substantial loss of moisture from the product.

Another advantage of carrying out the ultra-pasteurization of the VSP packages according to the present invention resides in the possibility of packaging the products also in easy-to-open type of VSP packages. Without using the protocol described in the present invention in case of an easy-to-open VSP package there might be the risk that in the first part of the ultra-pasteurization process the seal might leak due to the pressure exerted by the steam generated within the package that could break the seal or create a channel therein for its venting.

With respect to the conventional tray lidding packaging system, it has been shown that using VSP packages and applying the protocol according to the present invention the ultra-pasteurization process can be up to one third shorter. Times comprised between 25 and 120 minutes are generally sufficient to get the ultra-pasteurization of most of the ready meals on the market.

Object of the present invention is therefore a post-packaging ultra-pasteurization process for VSP packages, particularly suitable for extended shelf-life chilled ready meals, which process comprises setting the pressure of the retort vessel where the ultra-pasteurization of the VSP package is carried out, at a value comprised between 2 and 5 bar, prior to the initiation of the heating cycle, keeping the pressure within the above range during the whole heating cycle, carried out at a temperature and for a time sufficient to provide for a 6 log reduction in the count of cold growing non-proteolytic Clostridium botulinum spores, and for most of the cooling cycle until the packaged product almost reaches room temperature.

The ultra-pasteurization process of the present invention can be run in any of the retort apparatuses currently available on the market. For the heating step an infrared oven (e.g., an electric infrared oven or a gas infrared oven), a hot air convection or impingement oven, a steam oven, or an oven based on a combination of the above heating systems can be used. Steam ovens may operate within the temperature ranges generally used for the ready-meals post-package ultra-pasteurization, are cheaper and can be more easily employed, and are therefore the preferred ones. In particular ovens working with a wet-steam atmosphere and/or a more-or-less intensive hot water shower are widely known and used. Once the VSP packages are introduced in the retort vessel, generally in a multi-layer design to allow a certain number of VSP packages to be ultra-pasteurized in each cycle, the retort vessel, or autoclave, is closed and pressurized to a pressure value of at least 2 bar. The heating cycle is then initiated and the temperature is brought to the suitably selected value, typically comprised between 80 and 99° C., the packages are maintained at this temperature for the time needed to get the ultra-pasteurization of the packaged products, while still under the pressure initially set, the heating is then stopped and the packages are cooled, typically by means of cold water sprinkles, still keeping the pressure at the originally set value. As soon as the packages reach room temperature the pressure is released while the chilling process continues either inside or, preferably, outside the retort vessel and a new ultra-pasteurization cycle is then initiated.

The pasteurized VSP package thus obtained may be completed, with or without a prior drying step, by the addition of a cardboard or plastic label on the tray bottom or side-walls or preferably by the addition of a cardboard or plastic sleeve configured around it and containing the desired indication from the manufacturer, such as ingredients, nutritional indications and directions of use.

The packaging materials used for the VSP packages submitted to the ultra-pasteurization cycle need to withstand the temperatures used in the process without any degradation or irreversible deformation and without releasing more than 60 ppm of global contaminants to the packaged food in contact therewith.

The VSP packages include a bottom packaging portion and a top one, wherein the term “bottom” packaging portion refers to the part of the packaging material on which the product to be packaged is disposed, while the term “top” packaging portion refers to the flexible packaging material that will be over the product and will be covering it in the packaging process.

The top packaging portion is typically a formable multi-layer film suitable for VSP applications, designed to be sealable to the specific food contact layer of the bottom portion, and having gas-barrier properties, i.e., being characterized by an OTR (evaluated at 23° C. and 0% R.H. according to ASTM D-3985) of less than 500 cm³/m².day.bar.

The bottom packaging portion can be a flat support, an in-line thermoformed tray obtained from a continuous web or it may be a pre-made tray.

Considering that often the chilled ready meals are at least warmed up in a microwave or in a conventional oven, preferably at least the packaging material used for the bottom packaging portion would also be microwaveable or dual ovenable. Polypropylene and polyester (such as PET) are the materials that are typically used for the ovenable applications, optionally coupled (coextruded, laminated, or coated) with a gas-barrier coating and/or with a mono- or, preferably, multi-layer liner to provide at least for the desired gas-barrier properties.

More preferably also the packaging material of the top portion will be suitably selected to be microwaveable. In such a case, as indicated above, the end pasteurized VSP package could also be a self-venting one as the protocol used in the ultra-pasteurization process according to the present invention will ensure that the hermeticity of the package is anyway maintained during the ultra-pasteurization. In particular it would be possible to use the microwaveable self-venting VSP packages described e.g. in WO 03/020608.

1. A post-packaging ultra-pasteurization process for VSP packages comprising a packaged product, wherein the process comprises:
a. setting the pressure of a retort vessel where the ultra-pasteurization of the VSP packages is carried out, at a value of between 2 and 5 bar prior to the initiation of the heating cycle,
b. keeping the pressure within said range during the whole heating cycle and for most of the cooling cycle until said packaged product reaches about room temperature,
wherein said heating cycle is carried out at a temperature and for a time sufficient to provide for a 6 log reduction in the count of cold growing non-proteolytic Clostridium botulinum spores.

2. The process of claim 1, wherein the pressure in the retort vessel is selected from the group comprising: between 2 and 4 bar, between 2.1 and 4 bar, and between 2.3 bar and 4 bar.

3. The process of claim 1, wherein the pressure in the retort vessel is gradually decreased during the last part of the cooling cycle to reach the atmospheric value when said packaged product is at room temperature.

4. The process of claim 1, wherein the pressure in the retort vessel is maintained in a range selected from the group comprising: between 2 and 5 bar, or between 2 and 4 bar, until the packaged product reaches room temperature, and then is lowered to the atmospheric value during the further chilling of the package.

5. The process of claim 1, wherein the VSP packages are brought to a temperature of between about 80° C. and about 110° C., and maintained at said temperature for a period of time sufficient to provide a 6 log reduction in the count of cold growing non-proteolytic Clostridium botulinum spores.

6. The process of claim 5, wherein the VSP packages are brought to a temperature of between about 90° C. and about 99° C., and maintained at said temperature for a period of time sufficient to provide a 6 log reduction in the count of cold growing non-proteolytic Clostridium botulinum spores.

7. The process of claim 5, wherein the VSP packages are maintained for a period of time of from about 25 to about 200 minutes.

8. The process of claim 1, wherein said VSP packages comprise a bottom packaging portion and a too packaging portion, and wherein the bottom packaging portion is microwaveable or dual ovenable, and preferably the top packaging portion is microwaveable.

9. The process of claim 1, wherein said VSP packages are easy-to-open VSP packages package.

10. The process of claim 1, wherein said VSP packages are a microwaveable self-venting VSP packages.
